(19) United States
(12) Patent Application Publication
(10) Pub. No.: US 2007/0044824 A1
(43) Pub. Date: Mar. 1, 2007

(54) Processing system and method of processing

(76) Inventors: Scott William Capeci, Northbend, OH (US); Etienne Maria Betty Andre Jeuniaux, Merchtem (BE); Rajeev Ashok Modi, Cincinnati, OH (US); Kenneth Michael Kemen, Cincinnati, OH (US); Rebecca Lynn Gulaskey, Loveland, OH (US); Roger Phillip Williams, Cincinnati, OH (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/497,605

(22) Filed: Aug. 2, 2006

Related U.S. Application Data
(63) Continuation-in-part of application No. 11/217,273, filed on Sep. 1, 2005.
(63) Continuation-in-part of application No. 11/217,802, filed on Sep. 1, 2005.
(60) Provisional application No. 60/796,810, filed on May 2, 2006.

(51) Int. Cl. B08B 7/00

(52) U.S. Cl. 134/42

(57) ABSTRACT

This invention relates to a processing system, a method of processing and products produced by said process. Such system and method can reduce change over time and/or off quality product.

### CROSS-REFERENCES TO RELATED APPLICATIONS

This application claims priority under 35 U.S.C. § 119(e) to U.S. Provisional Application Ser. No. 60/796,810 filed May 2, 2006, and is a continuation-in-part of and claims priority under 35 U.S.C. § 120 to U.S. Patent Application Ser. No. 11/217,273 filed Sep. 1, 2005, and U.S. Patent Application Ser. No. 11/217,802 filed Sep. 1, 2005.

### FIELD OF INVENTION

This invention relates to a processing system, a method of processing and products produced by said process.

### BACKGROUND OF THE INVENTION

Current processing technologies, including processing systems and methods are continuingly improving. Unfortunately, the problems associated with product change over time, product quality and scrap/reblend have not been solved to the satisfaction of the processing community. The processing systems and methods disclosed herein, minimize the issues associated with such problems to the extent that further development effort may merely yield diminished returns.

### SUMMARY OF THE INVENTION

This invention relates to a processing system, a method of processing and products produced by said process. System and method can reduce change over time and/or off quality product.

### DETAILED DESCRIPTION OF THE INVENTION

Definitions

As used herein, the term “cleaning composition” includes, unless otherwise indicated, granular or powder-form all-purpose or “heavy-duty” washing agents, especially laundry detergents; liquid, gel or paste-form all-purpose washing agents, especially the so-called heavy-duty liquid types; liquid fine-fabric detergents; hand dishwashing agents or light duty dishwashing agents, especially those of the high-foaming type; machine dishwashing agents, including the various tablet, granular, liquid and rinse-aid types for household and institutional use; liquid cleaning, deodorizing and disinfecting agents, including antibacterial hand-wash types, laundry bars, air and fabric deodorizers mouthwashes, toothpastes, denture cleaners, car or carpet shampoos, bathroom cleaners; hair shampoos and hair-rinses; shower gels, body washes and foam baths and metal cleaners; as well as cleaning auxiliaries such as fabric enhancers, bleach additives and “stain-stick” or pre-treat types.

As used herein, combining refers to adding materials together with or without substantial mixing towards achieving homogeneity.

As used herein, mixing and blending interchangeably refer to combining and further achieving a relatively greater degree of homogeneity thereafter.

As used herein, the articles “a” and “an” when used in the specification or a claim, are understood to mean one or more of what is claimed or described.

As used herein, the terms “include”, “includes” and “including” are meant to be non-limiting.

As used herein, the phrase “is independently selected from the group consisting of . . .” means that moieties or elements that are selected from the referenced Markush group can be the same, can be different or any mixture of elements.

As used herein, a base material is a material that is employed as a sub-formulation and/or intermediate.

As used herein, a sub-formulation may be a single raw material.

As used herein, a finishing material is intended to be combined with at least one base material to produce a product that may be an intermediate or a finished product.

As used herein, “off line” means in a separate processing line or unit.

As used herein, “process residence time” is the average processing time as measured from material entry into the process to said materials exit from the process into a container. In one aspect of the invention, the “process residence time” is determined by dividing the total volume of the material throughout the process by the volumetric flow rate of said material at the exit point from said process.

Unless otherwise noted, all component or composition levels are in reference to the active level of that component or composition, and are exclusive of impurities, for example, residual solvents or by-products, which may be present in commercially available sources.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All documents cited are, in relevant part, incorporated herein by reference; the citation of any document is not to be construed as an admission that it is prior art with respect to the present invention.

### DETAILED DESCRIPTION OF THE INVENTION

Apparatus

An apparatus for combining, blending or mixing at least two materials, at least one of said material being a base material or a finishing material, and optionally reblend is disclosed. Once blended, said materials may constitute a cleaning composition.

The apparatus for adding the base material(s), finishing material(s) and optional reblend provides for some or all of these materials to come together in a confluence region. The confluence region may begin where the first two materials initially come into contact. Mixing may occur at the confluence region, downstream thereof, or in both locations. Such first two materials may be two base materials, two finishing materials, a base and a finishing material, a base material and reblend, or reblend and a finishing material. Such confluence region may comprise one or more inlets having inlet discharges through which base material(s), finishing materials and reblend(s) are supplied to said confluence region. Such inlet discharges may be spaced throughout the confluence region in any manner. For example, such inlet discharges may be in close proximity to each other or widely spaced apart and they may lie in a common plane or different planes. Thus, such inlet discharges may be equally or unequally spaced circumferentially, radially, and/or longitudinally. Further, the inlet discharges may have equal or unequal cross sectional areas, shapes, lengths and flow rates therethrough. In one aspect, the inlet discharges may be closely juxtaposed with an inline mixer, so that mixing of the materials occurs almost immediately in the confluence region. The base materials may be supplied to the inlet discharges from one or more common sources or from different sources. Likewise, the finishing materials and the optional reblends may be supplied to the inlet tubes from one or more common sources or from different sources.

The confluence region may further comprise at least one common outlet for discharging the base material(s), finishing material(s) and optional reblend(s) from the confluence region. The base and finishing material and optional reblend inlet discharges. terminate at or before said at least one common outlet for discharging the base material(s), finishing material(s) and optional reblend(s) from the confluence region. Said at least one common outlet for discharging the base material(s) finishing material(s) and optional reblend(s) may be designed such that the discharged matter flows into a container or into another unit for further processing. It is understood that after the materials leave the confluence region through the at least one common outlet, said materials may flow singularly or in parallel, in equal or unequal volumes and at equal or unequal flow rates, into a single container or plural containers having equal or unequal volumes. The container may be insertable into and removable from the apparatus. The apparatus may comprise apparatus hardware for adding at least one base to the container and a second through nth materials to the container. The container containing the said materials may be ultimately shipped and sold to the consumer, or may be used for transport and storage of the blend of base materials, finishing materials and optional reblends as an intermediate. Thus, the container may be selected from a bulk storage device, for example, a tank, a tank car, or rail car, or a final package, for example, a bottle. The container may be provided with a frangible or resealable closure as are well known in the art, and be made of any material suitable for containing the materials combined according to the present invention.

In one aspect, the finishing material(s) and/or base material(s) and optional reblend(s) are supplied to the confluence region by one or more inlet tube(s) inserted into the apparatus. The flow can be directed radially, circumferentially or even longitudinally or any other direction. Each base material, finishing material and optional reblend may have a dedicated inlet tube or, alternatively, plural base materials, finishing materials and/or optional reblends may be inserted through a single inlet tube. Of course, if desired, the base material, finishing material or reblend may be added through more than one inlet tube, in various combinations of like or different materials, quantities, feed rates, flow rates, concentrations, temperatures, etc.

In another aspect, the finishing material(s), base material(s) and/or optional reblend(s) are supplied to the confluence region at the wall of the pipe. The direction of flow of the injected material may be radial, circumferential or longitudinal in the confluence region or at other direction as desired.

In one aspect, a first material may be injected into the confluence region at a first velocity. The second through Nth materials may be injected into the confluence region at a second velocity, a third velocity, . . . up to N velocities for N finishing materials, base materials and/or optional reblend(s). The second through Nth velocities may be matched to, substantially the same as, or may be slightly different than the first velocity and each other. One or more of the finishing materials, base materials and/or optional reblend(s) may generally correspond with or be matched in flow velocity at the time of entry into the confluence region to the velocity of the previously injected materials. In one aspect, any or all of the second through Nth velocities of the aforementioned materials and/or optional reblend(s) may be from about 50% to about 500%, from about 75% to about 400% or even from about 100% to about 300% of the velocity of the previously injected material(s). This arrangement allows the aforementioned materials and/or optional reblend(s) to enter the flow as a continuous stream, without dribbling, and thereby promote better mixing. The discharge speed of the aforementioned materials and/or optional reblend(s) into the flow stream is determined by a combination of the discharge orifice (if any) and the output of the pump supplying the aforementioned materials and/or optional reblend(s). In a degenerate case, the first velocity may be identically matched to any or all of the second through Nth velocities.

In one aspect, the apparatus and method taught herein may utilize plural confluence regions. Said plural confluence regions may be disposed in series, in parallel, or a combination thereof. Said plural confluence regions may be identical or different in any or all of their base materials, finishing materials, optional reblends, proportions, flow rates, command signals, etc. Certain plural confluence regions may be used to premix finishing materials, base materials, optional reblends or any combination thereof to be mixed with other materials in later-occurring confluence regions.

The modules for supplying the base materials, finishing materials and optional reblends may comprise pipes, conduits, open channels, or any other suitable equipment through which the materials may flow. For example, a pipe having a desired cross section, constant or variable, may be utilized.

The apparatus and method described and claimed herein may have but do not require a dynamic mix region that is capable of back blending in time, such as a dynamic mix tank. As used herein, a mix tank refers to tanks, vats, vessels, reactors and dominant bath systems and is inclusive of the batch and continuous stir systems which use an impeller, jet mixing nozzle, a recirculating loop, gas percolation, rotating or fixed screen or similar means of agitation to combine materials therein. It can be difficult to quickly and accurately follow and achieve desired transient flow rates using a dynamic mix tank. This is because flow stagnation and interruption may occur while materials are being combined in a dynamic mix tank. Different proportions of flow rates can occur and prevent the desired product formulation from being achieved. If the desired formulation is not achieved, product is wasted. Furthermore, the residence time and energy input that is often necessary to achieve mixing and axial dispersion of the materials may be difficult to achieve with multiple additions of finishing materials.

In one aspect, a dynamic mix tank is employed. The dynamic tank can be used to dampen variations in product composition and to aid in changing over between products or different compositions of the same product. The mix tank can be located before or after the confluence region or regions or in between multiple confluence regions and can constitute a confluence region on its own. Each mix tank may further comprise at least one said common outlet for discharging the base material(s) and finishing material(s) from the mix tank. The mix tank can be under pressure or at atmospheric—if under pressure it may have an air-liquid contact surface.

In one aspect when the dynamic mix tank has an air liquid contact surface, it is designed with material inlets that are under the normal operating liquid level. This can be accomplished in a number of ways known to one of ordinary skill in the art such as low level nozzles or dip tubes. This design prevents aeration of the liquid which makes the liquid harder to handle and accurately meter. Mixing can be accomplished via impeller, jet mixing nozzle, a recirculating loop, gas percolation, or similar means of agitation to combine materials therein. The system for mixing type and intensity may be designed to minimize aeration.

During a changeover, the input of a material selected from the group consisting of a base material, a finishing material, a reblend material or combinations thereof injected prior to the dynamic mix region can be reduced or stopped before the end of the run. The upstream confluence region or regions can then be purged with a material selected from the group consisting of base material, a finishing material, a reblend material, air, water, steam or combinations thereof. The material purged from the confluence region is blended, in the dynamic mix region, with other materials to form acceptable product. Upon restart of the process, an excess of a material selected from the group consisting of a base material, a finishing material, a reblend material or combinations thereof can be added, for a predetermined period of time, to any material from the previous run that was up stream of the dynamic mix region and subsequently transferred to said region. Thus, said product and said excess of one or more ingredients is blended, in the dynamic mix region, to form acceptable product.

In one aspect, during change over, the product from the exit of the dynamic mix tank to the process outlet may be purged from such space using a fluid, including but not limited to air.

The apparatus described and claimed herein may utilize an inline mixer. As used herein an inline mixer refers to a mixing device which does not impute macro-scale flow stagnation, or prevent a continuous flow through portion of the apparatus having the inline mixer from occurring. One non-limiting type of inline mixer is, for example, an ultrasonic or cavitation type mixer. One such system is a Sonolator homogenizing system available from Sonic Corporation of Stratford, Conn. Another non-limiting type of inline mixer is a static mixer as known in the art and disclosed in U.S. Pat. No. 6,186,193 B1, issued Feb. 13, 2001 to Phallen et al. and in commonly assigned U.S. Pat. No. 6,550,960 B2, issued Apr. 22, 2003 to Catalfamo et al.; U.S. Pat. No. 6,740,281 B2, issued May 25, 2004 to Pinyayev et al.; U.S. Pat. No. 6,743,006 B2, issued Jun. 1, 2004 to Jaffer et al.; and U.S. Pat. No. 6,793,192 B2, issued Sep. 21, 2004 to Verbrugge. Another non-limiting type of inline mixer is, for example, a high shear mill such as those available from IKA Works, Wilmington N.C. Further, if desired, static mixers or other inline mixers may be disposed in or with one or more of the inlet tubes or upstream of the confluence region. Additionally, surge tanks may be used to provide more constant flow for materials combined by the apparatus and method described and claimed herein. Additionally or alternatively a Zanker plate may be utilized.

The base material(s), finishing material(s) and/or reblend(s) may comprise a fluid, typically a liquid, although gaseous base materials, finishing materials and reblends are contemplated. Liquids are inclusive of suspensions, emulsions, slurries, aqueous and nonaqueous materials, pure materials, blends of materials, etc., all having a liquid state of matter.

Optionally, at least one of the base materials, one or more of the finishing materials and/or one or more of the optional reblends may comprise a solid, such as a granular or particulate substance. Granular or particulate materials may be added in any known fashion, including but not limited to that disclosed in U.S. Pat. No. 6,712,496 B2.

While the apparatus may use any motive force or similar means for supplying the base material(s), finishing material(s) and optional reblend(s), including pumps and servomotors. As used herein motive force refers to any force used to provide energy which, in turn, is used to supply materials to the confluence region and may include, without limitation, electric motors, gravity feeds, manual feeds, hydraulic feeds, pneumatic feeds, etc.

The at least one base material(s) and/or at least one finishing material(s) and any optional reblend(s) may be supplied from a hopper, tank, reservoir, pump, such as a positive displacement pump, or other supply or source to the pipe, or other supply devices, as are known in the art and provide the desired accuracy for dosing such materials. The base material(s) and/or finishing material(s) may be supplied via a pump, auger feed, or any other suitable means.

The apparatus for providing the base material(s), finishing material(s) and/or any optional reblend(s) may comprise a plurality of positive displacement pumps. Each pump may be driven by an associated motor, such as an AC motor or a servomotor. Each servomotor may be dedicated to a single pump or optionally may drive plural pumps. This arrangement eliminates the necessity of having flow control valves, flow meters and associated flow control feedback loops as are used in the prior art.

As used herein, a flow control valve refers to a valve quantitatively used to allow a specific quantity or flow rate of material to pass thereby and is used to modulate actual flow rate. A flow control valve does not include an on-off valve which allows the process according to the present invention to qualitatively start or stop.

The apparatus used and described herein may also employ an automatic control system. The control system may consist of any of a number of options available in the industry and known by one who is of ordinary skill in the art. One particularly suitable approach is to use a Programmable Logic Controller (PLC) such as Allen Bradley's ControlLogix® available from Rockwell Automation, Milwaukee, Wis. An operator interface may also be provided such as a personal computer with Wonderware (R) software.

The apparatus described herein may also contain pumps or pressure regulating devices. These can used to provide adequate and consistent pressure at any point in the apparatus where it is required including the said at least one common outlet.

In one aspect, one or more processing apparatuses disclosed herein may be employed and the product produced by employing such apparatuses may be discharged into a common container, thereby forming for example, a product having multiple layers, patterns etc. Such layered and/or patterned product may or may not mix in the container to form a homogeneous product.

In one aspect, one or more processing apparatuses disclosed herein may be employed in conjunction with one or more additional processing apparatuses, for example, a simple source of material such as a tank with an outlet and the product produced by employing such apparatuses may be discharged into a common container, thereby forming for example, a product having multiple layers, patterns etc. Such layered and/or patterned product may or may not mix in the container to form a homogeneous product.

In one aspect, the processing apparatuses described herein and/or their components may be designed to be modular units that may be easily added to or deleted from a total process.

In one aspect of Applicants' invention, said apparatus for combining, blending or mixing at least two materials may have and/or comprise any combination of the parameters described in the present specification.

Process

Processes for combining, blending or mixing at least two materials, at least one of said material being a base material or a finishing material, are disclosed. Once blended, said materials may constitute a cleaning composition. A process for reducing or eliminating scrap is also disclosed.

In one aspect, such process may comprise contacting, in one or more confluence regions: at least two base materials; or at least two finishing materials; or one or more base materials and one or more finishing materials; and optionally one or more reblends. Mixing said at least two base materials; or at least two finishing materials; or one or more base materials and one or more finishing materials and said optional one or more reblends in said one or more confluence regions; or one or more regions outside of said one or more confluence regions; or in a combination of said one or more confluence regions and one or more regions outside of said one or more confluence regions. Placing said at least two base materials; or at least two finishing materials; or one or more base materials and one or more finishing materials and said optional one or more reblends in a container.

In one aspect, such process may comprise contacting said at least two base materials; or at least two finishing materials; or one or more base materials and one or more finishing materials with one or more reblends in said one or more confluence regions.

In one aspect, such process may comprise contacting said at least two base materials; or at least two finishing materials; or one or more base materials and one or more finishing materials; and optionally one or more reblends in more than one confluence region. Such aspect may find particular utility when aforementioned materials and/or optional reblend(s) are incompatible prior to product formation and/or require pre-complexing before being employed in a product.

In one aspect, such process may comprise contacting said at least two base materials; or at least two finishing materials; or one or more base materials and one or more finishing materials; and optionally one or more reblends in a single confluence region.

In one aspect, such process may comprise mixing said at least two base materials; or at least two finishing materials; or one or more base materials and one or more finishing materials and optionally one or more reblends in: more than one confluence region; or more than one region outside of said confluence regions; or in a combination of said more than one confluence regions and more than one region outside of said confluence regions.

In one aspect, such process may comprise, at least partially mixing said at least two base materials; or at least two finishing materials; or one or more base materials and one or more finishing materials and optionally one or more reblends in a single confluence region.

In one aspect, such process may be conducted such that the last material supplied to the confluence region comprises a base material, finishing material or reblend, said base material, finishing material or reblend being supplied after the process flow has been dynamically mixed and, after said base material, finishing material or reblend has been added to said process flow, said process flow being optionally further mixed, said further mixing being optionally conducted via a static mixer.

In one aspect, such process may comprise mixing said at least two base materials; or at least two finishing materials; or one or more base materials and one or more finishing materials; and optionally one or more reblends, at least partially, in said container.

In one aspect, such process may comprise contacting said at least two base materials; or at least two finishing materials; or one or more base materials and one or more finishing materials; and optionally one or more reblends simultaneously, sequentially or in any combination thereof.

In one aspect, of such process, said contacting step may be conducted such that one or more of the following apply:
a.) the materials being placed in contact are in parallel flow at the time of contact;
b.) that the flow velocities of the materials being placed in contact are, at the point of contact, from about 50% to about 500%, from about 75% to about 400% or even from about 100 to about 300% of the velocity of the previously injected material(s).
c.) the material having the smallest volumetric flow is introduced such that said flow is along the centerline of the confluence region.

In one aspect, such process may comprise mixing, in whole or in part, via turbulent flow mixing, static mixing, dynamic mixing or a combination thereof.

In one aspect, such process may comprise mixing in line, off-line or a combination thereof.

In one aspect, such process may comprise mixing under one or more of the following processing conditions:
a.) average shear rate is greater than about 10 sec⁻¹, greater than 300 sec⁻¹, from about 2000 sec⁻¹ to about 40,000 sec⁻¹ or even from about 40,000 sec⁻¹ to about 250,000 sec⁻¹
b.) power per unit volume greater than about 0.01 horsepower/gallon, greater than about 0.1 horsepower/gallon, from about 1.0 to about 150 horsepower/gallon, or even from about 10 to about 1500 horsepower/gallon;
c.) when a back mix tank is employed, mixing in said tank under one or more of the following process conditions:
   (i) residence time of the material in said back mix tank is greater than about 5 seconds, greater than about 30 seconds, or even from about 1 to about 4 minutes;
   (ii) the power per unit volume, in horsepower/gallon of material in said tank, is from about 0.000001 to about 0.15, from about 0.00001 to about 0.010, or even from about 0.00001 to about 0.005;

(iii) the Chemscale of mixing is from about 0.5 to about 10, from about 0.5 to about 6, or even from about 1 to about 4.

In one aspect, such process may be conducted such that the process residence time of the first material to enter the first confluence region is less than about 5 minutes, less than about 30 seconds, or even from about 5 seconds to about 0.5 seconds.

In one aspect of Applicants' invention, said process for combining, blending or mixing at least two materials apparatus for combining, blending or mixing at least two materials may have and/or comprise any combination of the parameters described in the present specification.

A process of reducing scrap and/or reblend is also disclosed. Such process may comprise one or more of the following:
a.) positioning one or more confluence regions, in relation to a container, such that the process residence time of the first material to enter the first confluence region is less than about 5 minutes, less than about 30 seconds, or even from about 5 seconds to about 0.5 seconds
b.) stopping or reducing the input of a material selected from the group consisting of a base material, a finishing material a reblend material or combination thereof into a confluence region;
c.) purging said one or more confluence regions;
d.) introducing an excess of a material selected from the group consisting of a base material, a finishing material a reblend material or combination thereof into a confluence region.

In one aspect, such process of reducing scrap and/or reblend may comprise purging with a composition that has a material composition that results from stopping or reducing the input of a material selected from the group consisting of a base material, a finishing material, or a reblend material.

In one aspect, such process of reducing scrap and/or reblend may comprise purging with a composition selected from the group consisting of a base material, a finishing material, a reblend material, air, steam, water or combination thereof.

In one aspect, such process of reducing scrap and/or reblend said excess material may be compositionally different from said material that is stopped or reduced.

In one aspect, such process of reducing scrap and/or reblend may comprise purging any outlet region downstream of said one or more confluence regions.

In one aspect, such process of reducing scrap and/or reblend may comprise operating a processing system comprising a dynamic mix region positioned downstream of said one or more confluence regions and an outlet region downstream of said dynamic mix region as follows:
a.) sequentially stopping the input of one or more base materials, finishing materials and/or reblends in to said one or more confluence regions while maintaining the input of at least one other base material, finishing material and/or reblend in to said one or more confluence regions;
b.) stopping the input of said at least one other base material, finishing material and/or reblend in to said one or more confluence regions when said at least one other base material, finishing material and/or reblend reaches the input to said dynamic mix region;
c.) substantially emptying said dynamic mix region and optionally purging said outlet region;
d.) supplying to said dynamic mix region said at least one other base material, finishing material and/or reblend contained in said confluence region, and a sufficient amount of additional base materials, finishing materials and/or reblends to said dynamic mix region to form product in said dynamic mix region;
e.) regulating the input of base materials, finishing materials and/or reblends into said one or more confluence regions such that the formation of product in said dynamic mix region is maintained.

In one aspect of such process of reducing scrap and/or reblend at least one other base material, finishing material and/or reblend may comprise water.

In one aspect, such process of reducing scrap and/or reblend may comprise substantially purging said outlet region.

In one aspect of Applicants' invention, said process for reducing or eliminating scrap may have and/or comprise any combination of the parameters described in the present specification.

In one aspect, one or more of the aspects of said process for reducing or eliminating scrap may be combined with one or more aspects of said process for combining, blending or mixing at least two material.

Base and Finishing Materials

While any base material may be used, suitable base materials include detergent bases. Suitable detergent bases include base materials listed in Table 1 below.

| Material | Base 1 | Base 2 | Base 3 |
|---|---|---|---|
| C25 AE1.8S | 25 | 17 | 28 |
| HLAS | 6.5 | 1.5 | 7.0 |
| Nonionic | | 1.5 | |
| Surfactant | | | |
| Amine Oxide | 2 | | 2.5 |
| Citric Acid | 7 | 4.5 | 7.5 |
| Fatty Acid | 2.5 | 0.40 | 2 |
| Borax | 4 | 2.5 | 4.5 |
| Calcium Formate | 0.9 | 1.00 | 0.95 |
| DTPA | 0.4 | 0.7 | 0.45 |
| Brightener | 2 | 0.65 | 2.5 |
| Propanediol | 2.5 | 0.50 | 3 |
| NaOH | 4 | 1 | 5 |
| Viscosity | | 2.5 | |
| Modifier | | | |
| Enzymes | 1.2 | 1.4 | 1.2 |
| Polymers | 2.4 | 0.9 | 2.4 |
| Water | Balance | Balance | Balance |

Suitable finishing materials include materials selected from the group consisting of enzymes, bleaches, polymers, perfumes, dyes, surfactants, fatty acids, salts and water.

Materials

While not essential for the purposes of the present invention, the non-limiting list of materials, in addition to the previously disclosed base materials, a finishing materials, and reblend materials, illustrated hereinafter are suitable for use in the process disclosed herein to produce compositions, including cleaning compositions, and may be desirably incorporated in certain embodiments, for example to assist or enhance cleaning performance, for treatment of the substrate to be cleaned, or to modify the aesthetics of the cleaning composition as is the case with perfumes, colorants, dyes or the like. The precise nature of these additional components, and levels of incorporation thereof, will depend on the physical form of the composition and the nature of the cleaning operation for which it is to be used. Suitable materials include, but are not limited to, surfactants, builders, chelating agents, dye transfer inhibiting agents, dispersants, enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, perfumes, structure elasticizing agents, fabric softeners, structurants, carriers, hydrotropes, processing aids, solvents and/or pigments. The aforementioned materials may or may not serve as adjunct ingredients. In addition to the disclosure herein, suitable examples of adjuncts and levels of use are found in U.S. Pat. Nos. 5,576,282, 6,306,812 B1 and 6,326,348 B1 that are incorporated by reference.

As stated, the adjunct ingredients are not essential to Applicants' compositions. Thus, certain embodiments of Applicants' compositions do not contain one or more of the following adjuncts materials: surfactants, builders, chelating agents, dye transfer inhibiting agents, dispersants, enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, perfumes, structure elasticizing agents, fabric softeners, carriers, hydrotropes, processing aids, solvents and/or pigments. However, when one or more adjuncts are present, such one or more adjuncts may be present as detailed below:

Bleaching Agents—The cleaning compositions of the present invention may comprise one or more bleaching agents. Suitable bleaching agents other than bleaching catalysts include photobleaches, bleach activators, hydrogen peroxide, sources of hydrogen peroxide, pre-formed peracids and mixtures thereof. In general, when a bleaching agent is used, the compositions of the present invention may comprise from about 0.1% to about 50% or even from about 0.1% to about 25% bleaching agent by weight of the subject cleaning composition. Examples of suitable bleaching agents include:

(1) photobleaches for example sulfonated zinc phthalocyanine;

(2) preformed peracids: Suitable preformed peracids include, but are not limited to, compounds selected from the group consisting of percarboxylic acids and salts, percarbonic acids and salts, perimidic acids and salts, peroxymonosulfuric acids and salts, for example, Oxzone®, and mixtures thereof. Suitable percarboxylic acids include hydrophobic and hydrophilic peracids having the formula R—(C═O)O—O—M wherein R is an alkyl group, optionally branched, having, when the peracid is hydrophobic, from 6 to 14 carbon atoms, or from 8 to 12 carbon atoms and, when the peracid is hydrophilic, less than 6 carbon atoms or even less than 4 carbon atoms; and M is a counterion, for example, sodium, potassium or hydrogen;

(3) sources of hydrogen peroxide, for example, inorganic perhydrate salts, including alkali metal salts such as sodium salts of perborate (usually mono- or tetra-hydrate), percarbonate, persulphate, perphosphate, persilicate salts and mixtures thereof. In one aspect of the invention the inorganic perhydrate salts are selected from the group consisting of sodium salts of perborate, percarbonate and mixtures thereof. When employed, inorganic perhydrate salts are typically present in amounts of from 0.05 to 40 wt %, or 1 to 30 wt % of the overall composition and are typically incorporated into such compositions as a crystalline solid that may be coated. Suitable coatings include, inorganic salts such as alkali metal silicate, carbonate or borate salts or mixtures thereof, or organic materials such as water-soluble or dispersible polymers, waxes, oils or fatty soaps; and

(4) bleach activators having R—(C═O)-L wherein R is an alkyl group, optionally branched, having, when the bleach activator is hydrophobic, from 6 to 14 carbon atoms, or from 8 to 12 carbon atoms and, when the bleach activator is hydrophilic, less than 6 carbon atoms or even less than 4 carbon atoms; and L is leaving group. Examples of suitable leaving groups are benzoic acid and derivatives thereof—especially benzene sulphonate. Suitable bleach activators include dodecanoyl oxybenzene sulphonate, decanoyl oxybenzene sulphonate, decanoyl oxybenzoic acid or salts thereof, 3,5,5-trimethyl hexanoyloxybenzene sulphonate, tetraacetyl ethylene diamine (TAED) and nonanoyloxybenzene sulphonate (NOBS). Suitable bleach activators are also disclosed in WO 98/17767. While any suitable bleach activator may be employed, in one aspect of the invention the subject cleaning composition may comprise NOBS, TAED or mixtures thereof.

When present, the peracid and/or bleach activator is generally present in the composition in an amount of from about 0.1 to about 60 wt %, from about 0.5 to about 40 wt % or even from about 0.6 to about 10 wt % based on the composition. One or more hydrophobic peracids or precursors thereof may be used in combination with one or more hydrophilic peracid or precursor thereof.

The amounts of hydrogen peroxide source and peracid or bleach activator may be selected such that the molar ratio of available oxygen (from the peroxide source) to peracid is from 1:1 to 35:1, or even 2:1 to 10:1.

Surfactants—The cleaning compositions according to the present invention may comprise a surfactant or surfactant system wherein the surfactant can be selected from nonionic surfactants, anionic surfactants, cationic surfactants, ampholytic surfactants, zwitterionic surfactants, semi-polar nonionic surfactants and mixtures thereof. When present, surfactant is typically present at a level of from about 0.1% to about 60%, from about 1% to about 50% or even from about 5% to about 40% by weight of the subject composition.

Builders—The cleaning compositions of the present invention may comprise one or more detergent builders or builder systems. When a builder is used, the subject composition will typically comprise at least about 1%, from about 5% to about 60% or even from about 10% to about 40% builder by weight of the subject composition.

Builders include, but are not limited to, the alkali metal, ammonium and alkanolammonium salts of polyphosphates, alkali metal silicates, alkaline earth and alkali metal carbonates, aluminosilicate builders and polycarboxylate compounds, ether hydroxypolycarboxylates, copolymers of maleic anhydride with ethylene or vinyl methyl ether, 1, 3, 5-trihydroxy benzene-2, 4, 6-trisulphonic acid, and carboxymethyloxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, citric acid, oxydisuccinic acid, polymaleic acid, benzene 1,3,5-tricarboxylic acid, carboxymethyloxysuccinic acid, and soluble salts thereof.

Chelating Agents—The cleaning compositions herein may contain a chelating agent. Suitable chelating agents include copper, iron and/or manganese chelating agents and mixtures thereof. When a chelating agent is used, the subject composition may comprise from about 0.005% to about 15% or even from about 3.0% to about 10% chelating agent by weight of the subject composition.

Dye Transfer Inhibiting Agents—The cleaning compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in a subject composition, the dye transfer inhibiting agents may be present at levels from about 0.0001% to about 10%, from about 0.01% to about 5% or even from about 0.1% to about 3% by weight of the composition.

Brighteners—The cleaning compositions of the present invention can also contain additional components that may tint articles being cleaned, such as fluorescent brighteners. Suitable fluorescent brightener levels include lower levels of from about 0.01, from about 0.05, from about 0.1 or even from about 0.2 wt % to upper levels of 0.5 or even 0.75 wt %.

Dispersants—The compositions of the present invention can also contain dispersants. Suitable water-soluble organic materials include the homo- or co-polymeric acids or their salts, in which the polycarboxylic acid comprises at least two carboxyl radicals separated from each other by not more than two carbon atoms.

Enzymes—The cleaning compositions can comprise one or more enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination is an enzyme cocktail that may comprise, for example, a protease and lipase in conjunction with amylase. When present in a cleaning composition, the aforementioned enzymes may be present at levels from about 0.00001% to about 2%, from about 0.0001% to about 1% or even from about 0.001% to about 0.5% enzyme protein by weight of the composition.

Enzyme Stabilizers—Enzymes for use in detergents can be stabilized by various techniques. The enzymes employed herein can be stabilized by the presence of water-soluble sources of calcium and/or magnesium ions in the finished compositions that provide such ions to the enzymes. In case of aqueous compositions comprising protease, a reversible protease inhibitor, such as a boron compound, can be added to further improve stability.

Catalytic Metal Complexes—Applicants' cleaning compositions may include catalytic metal complexes. One type of metal-containing bleach catalyst is a catalyst system comprising a transition metal cation of defined bleach catalytic activity, such as copper, iron, titanium, ruthenium, tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra(methylenephosphonic acid) and water-soluble salts thereof. Such catalysts are disclosed in U.S. Pat. No. 4,430,243.

If desired, the compositions herein can be catalyzed by means of a manganese compound. Such compounds and levels of use are well known in the art and include, for example, the manganese-based catalysts disclosed in U.S. Pat. No. 5,576,282.

Cobalt bleach catalysts useful herein are known, and are described, for example, in U.S. Pat. No. 5,597,936; U.S. Pat. No. 5,595,967. Such cobalt catalysts are readily prepared by known procedures, such as taught for example in U.S. Pat. No. 5,597,936, and U.S. Pat. No. 5,595,967.

Compositions herein may also suitably include a transition metal complex of ligands such as bispidones (WO 05/042532 A1) and/or macropolycyclic rigid ligands—abbreviated as “MRLs”. As a practical matter, and not by way of limitation, the compositions and processes herein can be adjusted to provide on the order of at least one part per hundred million of the active MRL species in the aqueous washing medium, and will typically provide from about 0.005 ppm to about 25 ppm, from about 0.05 ppm to about 10 ppm, or even from about 0.1 ppm to about 5 ppm, of the MRL in the wash liquor.

Suitable transition-metals in the instant transition-metal bleach catalyst include, for example, manganese, iron and chromium. Suitable MRLs include 5,12-diethyl-1,5,8,12-tetraazabicyclo[6.6.2]hexadecane.

Suitable transition metal MRLs are readily prepared by known procedures, such as taught for example in WO 00/32601, and U.S. Pat. No. 6,225,464.

Solvents—Suitable solvents include water and other solvents such as lipophilic fluids. Examples of suitable lipophilic fluids include siloxanes, other silicones, hydrocarbons, glycol ethers, glycerine derivatives such as glycerine ethers, perfluorinated amines, perfluorinated and hydrofluoroether solvents, low-volatility nonfluorinated organic solvents, diol solvents, other environmentally-friendly solvents and mixtures thereof.

Perfume and Perfume Systems—Suitable perfumes include neat perfume and perfume systems. Suitable perfume systems include polymer assisted delivery systems including classical coacervation, liquid crystals, hot melts, hydrogels, microcapsules, nano- and micro-latexes. Certain suitable polymer assisted delivery systems as well as methods of making and using same can be found in USPA 2005/0003980 A1; silicone assisted delivery systems, for example perfume loaded silicones; amine assisted delivery systems including amine assisted delivery disclosed in USPA 2005/0003980 A1; amine reaction product delivery systems including amine reaction product delivery systems disclosed in USPA 2005/0003980 A1 and U.S. Pat. No. 6,413,920; cyclodextrin systems including cyclodextrin systems disclosed in USPA 2005/0003980 A1 and U.S. Pat. Nos. 5,552,378; 3,812,011; 4,317,881; 4,418,144; and 4,378,923; starch encapsulated accord delivery systems including starch encapsulated accord delivery systems disclosed in USPA 2005/0003980 A1 and U.S. Pat. No. 6,458,754; zeolite and inorganic carriers delivery systems including inorganic carriers delivery systems disclosed in USPA 2005/0003980 A1 and U.S. Pat. No. 5,858,959, pro-perfume including Michael adducts (beta-amino ketones), Schiff bases (imines), oxazolidines, beta-keto esters, and orthoesters,

Products

A variety of products, including cleaning and/or treatment compositions may be produced by the processes disclosed herein. In one aspect, conventional body wash and/or personal cleansing compositions can be made according to the processes and by the systems of the present invention. Some examples of personal cleansing composition include those more fully described in the co-pending patent applications U.S. Patent Publication No. 2006/0083761A1 entitled Personal care compositions comprising visible beads, cationic polymer, and surfactant filed on Oct. 12, 2005 published on Apr. 20, 2006; U.S. Patent Publication No. 2004/0223991 entitled “Multi-phase Personal Care Compositions” filed on May 7, 2004, published on Nov. 11, 2004; U.S. Patent Publication No. 2004/0057920 A1 entitled “Striped liquid personal cleansing compositions containing a cleansing phase and a separate benefit phase” filed by Focht, et al. on Sep. 18, 2003, published on Apr. 4, 2004, U.S. Patent Publication No. 2004/0092415 A1 entitled “Striped liquid personal cleansing compositions containing a cleansing phase and a separate benefit phase with improved stability” filed by Focht, et al. on Oct. 31, 2003, published on May 13, 2004 and U.S. Patent Publication No. 2004/0219119 A1 entitled “Visually distinctive multiple liquid phase compositions” filed by Weir, et al. on Apr. 30, 2004, published on Nov. 18, 2004 and U.S. Application Ser. No. 60/680,149 entitled “Structured Multi-phased Personal Cleansing Compositions Comprising Branched Anionic Surfactants” filed on May 12, 2004 by Smith, et al.

In another aspect, oral care products may be produced by the processes disclosed herein. Suitable dentifrice bases include base materials listed in Table 2 below, including but not limited to carriers/solvent, humectants, abrasives, tartar control agents, antimicrobials, fluoride sources and anticaries agents, buffer/pH adjusting agents, stabilizing agents, thickening/structuring agents, binders, flavors and sweetening agents and surfactants. Active and other materials useful in the products herein are categorized or described by their cosmetic and/or therapeutic benefit or their postulated mode of action or function. However, it is to be understood that the active and other materials useful herein can, in some instances, provide more than one cosmetic and/or therapeutic benefit or function or operate via more than one mode of action. Therefore, classifications herein are made for the sake of convenience and are not intended to limit an ingredient to the particularly stated application or applications listed. The amount shown in weight % for each material is the amount in the final product after addition of finishing and/or reblend materials.

TABLE 2

| Base Material | 2A | 2B | 2C | 2D | 2E | 2F | 2G |
|---|---|---|---|---|---|---|---|
| Water | 38.51 | 23.26 | 23.26 | 8.0 | 8.95 | 13.7 | |
| Glycerin | | | | 9.00 | | 7.750 | 36.944 |
| Sorbitol 70% soln. | 24.21 | 33.80 | 32.80 | 41.0 | 60.0 | 24.91 | |
| Polyethylene Glycol 300 | | 3.720 | 3.720 | 3.00 | | 6.00 | 7.000 |
| Propylene Glycol | | | | | | | 7.000 |
| Silica Z-109 | | | 7.667 | | | | 12.500 |
| Silica Z-119 | 21.00 | 17.00 | 9.333 | 17.0 | 15.0 | 31.0 | 12.500 |
| Tetrasodium Pyrophosphate | | 1.128 | 1.128 | 3.850 | | 5.045 | |
| Disodium Pyrophosphate | | 1.344 | 1.344 | 1.0 | | | |
| Tetrapotassium Pyrophosphate | | 3.159 | 3.159 | | | | |
| Sodium Polyphosphate | | | | | | | 13.000 |
| Sodium Fluoride | 0.32 | 0.321 | 0.321 | 0.243 | 0.243 | 0.243 | |
| Stannous Fluoride | | | | | | | 0.454 |
| Triclosan/PEG Premix | | 0.560 | 0.560 | | | | |
| Monosodium Phosphate | | | | | 0.419 | | |
| Trisodium Phosphate | 0.37 | | | | 1.10 | | 1.100 |
| Sodium Carbonate | | | | | | 0.500 | |
| Sodium Bicarbonate | | | | | | 1.500 | |
| Sodium Gluconate | | | | | | | 0.652 |
| Zinc Lactate Dihydrate | | | | | | | 2.500 |
| Xanthan Gum | | 0.500 | 0.500 | 0.475 | | | 0.250 |
| Carbomer 956 | 0.30 | 0.300 | 0.300 | 0.300 | 0.300 | | |
| Na Carboxymethylcellulose | 1.10 | 0.700 | 0.700 | | 0.750 | 0.750 | |
| Carrageenan | | | | | | | 0.600 |
| Sodium Saccharin | 0.20 | 0.200 | 0.200 | 0.40 | 0.130 | 0.350 | 0.500 |
| Sodium Lauryl Sulfate 28% Soln | 2.00 | | | 2.0 | 2.0 | 5.0 | 3.400 |
| Poloxamer | | | | | | 1.25 | |

While not essential for the purposes of the present invention, the following non-limiting list of finishing and reblend materials may optionally be added to the previously disclosed base materials using the process disclosed herein to produce final dentifrice products, and may be desirably incorporated in certain embodiments, for example to assist or enhance performance, or to modify the aesthetics of the composition as is the case with flavors, colorants, dyes or the like. The precise nature of these additional components, and levels of incorporation thereof, will depend on the final desired composition. Finishing and reblend materials suitable for the preparation of compositions of the present invention are well known in the art. Their selection will depend on secondary considerations like taste, cost, and shelf stability, etc.

Suitable materials include, but are not limited to, surfactants, humectants, mouthwash compositions, water, flavors, extracts, pH adjusting agents, colorants and pigments, binders, cleaning agents, sweeteners, tartar control agents, antisensitivity agents, chelating agents, structurants, processing aids, and/or visual aesthetics such as mica, polyethylene specks, wax prills, and pigmented silica particles.

As stated, the adjunct ingredients are not essential to Applicants' compositions. Thus, certain embodiments of Applicants' compositions may not contain one or more of the above finishing and reblend adjunct materials.

Suitable base materials for a denture adhesive include bioadhesive materials and a non-aqueous vehicle. The bioadhesive materials include natural gums, synthetic polymeric gums, AVE/MA, salts of AVE/MA, AVE/MA/IB, salts of AVE/MA/IB, copolymer of maleic acid or anhydride and ethylene and salts thereof, copolymer of maleic acid or anhydride and styrene and salts thereof, copolymer of maleic acid or anhydride and isobutylene and salts thereof, polyacrylic acid and polyacrylates thereof, polyitaconic acid and salts thereof, synthetic polymers, mucoadhesive polymers, water-soluble hydrophilic colloids or polymers having the property of swelling upon exposure to moisture to form a mucilaginous mass, hydrophilic polymers, saccharide derivatives, cellulose derivatives, any adhesive material employed in denture stabilizing compositions, and mixtures thereof. Examples of such materials include karaya gum, guar gum, gelatin, algin, sodium alginate, tragacanth, chitosan, polyethylene glycol, polyethylene oxide, acrylamide polymers, carbopol, polyvinyl alcohol, polyamines, polyquartemary compounds, ethylene oxide polymers, polyvinylpyrrolidone, cationic polyacrylamide polymers, AVE/MA, AVE/MA/IB, mixed salts of AVE/MA, mixed salts of AVE/MA/IB, and mixtures thereof.

The non-aqueous vehicle is generally any chemical in any physical form that does not contain water. The non-aqueous vehicle is selected from liquid petrolatum, petrolatum, mineral oil, glycerin, natural and synthetic oils, fats, silicone and silicone derivatives, polyvinyl acetate, natural and synthetic waxes such as animal waxes like beeswax, lanolin and shellac, hydrocarbons, hydrocarbon derivatives, vegetable oil waxes such as carnauba, candelilla and bayberry wax, vegetable oils such as caprylic/capric triglycerides, corn, soy bean, cottonseed, castor, palm and coconut oils and animal oils such as fish oil and oleic acid, and mixtures thereof. Vegetable oils and other non-aqueous vehicles for denture adhesive compositions are further described in U.S. Pat. No. 5,561,177, issued on Oct. 1, 1996, Khaledi et al.

Finishing materials for base denture products include one or more components which provide flavor, fragrance, and/or sensate benefit (warming or cooling agents). Suitable components include natural or artificial sweetening agents, menthol, menthyl lactate, wintergreen oil, peppermint oil, spearmint oil, leaf alcohol, clove bud oil, anethole, methyl salicylate, eucalyptol, cassia, 1-menthyl acetate, sage, eugenol, parsley oil, oxanone, alpha-irisone, marjoram, lemon, orange, propenyl guaethol, cinnamon, vanillin, thymol, linalool, cinnamaldehyde glycerol acetal known as CGA, and mixtures-thereof, as well as coolants. The coolant can be any of a wide variety of materials. Included among such materials are carboxamides, menthol, ketals, diols, and mixtures thereof. Preferred coolants in the present compositions are the paramenthan carboxyamide agents such as N-ethyl-p-menthan-3-carboxamide, known commercially as “WS-3”, N,2,3-trimethyl-2-isopropylbutanamide, known as “WS-23,” and mixtures thereof. Additional preferred coolants are selected from the group consisting of menthol, 3-1-menthoxypropane-1,2-diol known as TK-10 manufactured by Takasago, menthone glycerol acetal known as MGA manufactured by Haarmann and Reimer, and menthyl lactate known as Frescolat® manufactured by Haarmann and Reimer. The terms menthol and menthyl as used herein include dextro- and levorotatory isomers of these compounds and racemic mixtures thereof. TK-10 is described in U.S. Pat. No. 4,459,425, Amano et al., issued Jul. 10, 1984. WS-3 and other agents are described in U.S. Pat. No. 4,136,163, Watson, et al., issued Jan. 23, 1979. These agents may be present at a level of from about 0% to about 50%, by weight of the composition.

In addition one or more toxicologically-acceptable plasticizers may also be included in the present compositions. The term “toxicologically-acceptable”, as used herein, is used to describe materials that are suitable in their toxicity profile for administration to humans and/or lower animals. Plasticizers that may be used in the present compositions include dimethyl phthalate, diethyl phthalate, dioctyl phthalate, glycerin, diethylene glycol, triethylene glycol, Igepal®, Gafac®, sorbitol, tricresyl phosphate, dimethyl sebacate, ethyl glycolate, ethylphthalyl ethyl glycolate, o- and p-toluene ethyl sulfonamide, and mixtures thereof. Plasticizers may be present at a level of from about 0% to about 70%, in another embodiment from about 1% to about 30%, by weight of the compositions.

Other suitable ingredients include colorants, preservatives (such as methyl and propyl parabens), thickeners such as silicon dioxide, and polyethylene glycol. Colorants, preservatives, thickeners may be present at levels of from about 0% to about 20%, by weight of the composition. Examples of colorants include the paste-like Opatint® products from Colorcon (West Point, Pa.) which contain lakes and/or dyes dispersed in liquids such as mineral oil and/or petrolatum. These lakes and dyes are selected from the group consisting of D&C Red 27, D&C Red 22, D&C Red 28, FD&C Red 3 and FD&C 40, Opatint-OD 1646, Opatint OD-1774, CAS#13473-26-2, 18472-87-2, 16423-68-0, 548-26-5, 2379-74-0, 915-67-3, 25956-17-6, and fluorescein dyes with chlorine and/or bromine. Examples of suitable colorants include tetrabromo-tetrachloro-fluorescein, disodium salt of tetrabromo-tetrachloro-fluorescein, Opatint OD-1646, D&C Red 27 and D&C Red 28. Opatint OD-1646, CAS#13473-26-2 is 2′, 4′, 5′, 7′-tetrabromo-4,5,6, 7-tetrachlorofluorescin, CAS# 18472-87-2 is disodium salt of 2′, 4′, 5′, 7′-tetrabromo4,5,6, 7-tetrafluorescein, CAS# 16423-68-0 is 3′6′-Dihydroxy-2′, 4′, 5′, 7-tetraiodosprio[isobenzofuran-1(3H),9′-(9-H)]xanthen]-3′-one-disodium salt, CAS# 548-26-5 is tetrabromo-3′,6′-dihydroxy-, disodium salt, CAS# 2379-74-0 also known as Japan Red 226 and Pigment Red 181 and as 5,5′-Dichloro-3,3′-dimethyl-Thioindigo, CAS# 915-67-3 is 6-hydroxy-5-[(2-methoxy-5-methyl-4-sulfophenyl)azo]-2-naphthalene-sulfonic acid disodium salt, CAS# 25956-17-6 is 6-Hydroxy-5-[(2-Methoxy-5-Methyl-4 -Sulfophenyl)Azo]-2-Naphthalenesulfonic Acid, disodium salt. The level of colorant may range from 0 to about 5%, in another embodiment from about 0.02% to about 2%, and in even another embodiment from about 0.05% to about 1% by weight of the composition.

The denture adhesive compositions may also comprise one or more therapeutic actives suitable for topical administration. Therapeutic actives may be present at a level of from about 0% to about 70%, by weight of the composition, and in one embodiment from about 1% to about 20% by weight of the composition. Therapeutic actives include antimicrobial agents such as iodine, tricolsan, peroxides, sulfonamides, bisbiguanides, or phenolics; antibiotics such as tetracycline, neomycin, kanamycin, metronidazole, cetylpyridium chloride, or clindamycin; anti-inflammatory agents such as aspirin, acetaminophen, naproxen and its salts, ibuprofen, ketorolac, flurbiprofen, indomethacin, eugenol, or hydrocortisone; dentinal desensitizing agents such as potassium nitrate, strontium chloride or sodium fluoride; fluorides such as sodium fluoride, stannous fluoride, MFP; anesthetic agents such as lidocaine or benzocaine; anti-fungals such as those for the treatment of Candida albicans; aromatics such as camphor, eucalyptus oil, and aldehyde derivatives such as benzaldehyde; insulin; steroids; herbal and other plant derived remedies; baking soda, and anti-neoplastics. It is recognized that in certain forms of therapy, combinations of these agents in the same delivery system may be useful in order to obtain an optimal effect. Thus, for example, an antimicrobial and an anti-inflammatory agent may be combined in a single delivery system to provide combined effectiveness.

Method of Use

The present disclosure includes a method for cleaning and/or treating a situs inter alia a surface or fabric. Such method includes the steps of contacting an embodiment of Applicants' cleaning composition, in neat form or diluted in a wash liquor, with at least a portion of a surface or fabric then optionally rinsing such surface or fabric. The surface or fabric may be subjected to a washing step prior to the aforementioned rinsing step. For purposes of the present invention, washing includes but is not limited to, scrubbing, and mechanical agitation. As will be appreciated by one skilled in the art, the cleaning compositions of the present invention are ideally suited for use in laundry applications. Accordingly, the present invention includes a method for laundering a fabric. The method comprises the steps of contacting a fabric to be laundered with a said cleaning laundry solution comprising at least one embodiment of Applicants' cleaning composition, cleaning additive or mixture thereof. The fabric may comprise most any fabric capable of being laundered in normal consumer use conditions. The solution preferably has a pH of from about 8 to about 10.5. The compositions may be employed at concentrations of from about 500 ppm to about 15,000 ppm in solution. The water temperatures typically range from about 5° C. to about 90° C. The water to fabric ratio is typically from about 1:1 to about 30:1.

### EXAMPLES

### Example 1

A typical liquid laundry detergent base, perfume and dye are introduced continuously, according to the material balance in the attached table, sequentially in a confluence region of a ¾″ pipe. The perfume and dye are added 12″ and 18″ downstream of the base respectively using an injection pipe. Each injection pipe is bent at a 90 angle to deliver the injected material parallel to the existing flow along the centerline of the pipe, and sized to give a material velocity within 20% of the average velocity of the existing flow. The confluence region is followed by a 12 element Kenics KM Static mixer (available from Kenos Inc. No Andover, Mass. USA) 6″ after the last injection. Total flow is 1.98 gallons/minute; velocity is 1.32 ft/sec; the average mixer shear rate is 370 sec−1; the mix energy is 0.107 HP/gallon. The static mixer is followed by a mix tank. This is a 12″ diameter tank, with 9″ of liquid level. The mix tank contained an A310, 3″ diameter, low viscosity hydrofoil agitator (available from Chemineer Inc, Dayton Ohio). Mixer energy is0.00031 hp/gallon and yielded a chemscale of 1. The mix tank continuously feeds the final container. A level controller maintains the liquid level by adjusting the outflow.

The process results in a finished detergent with the composition shown in the attached table and a viscosity of 300 cp.

### Example 2

The same materials as in example 1 are continuously fed into a 1″ confluence region. The perfume and dye are injected 12″ and 14″ downstream of the base respectively. Each injection pipe is bent at a 90 angle to deliver the injected material parallel to the existing flow along the centerline of the pipe, and sized to give a material velocity within 20% of the average velocity of the existing flow. The confluence region is followed by a 24 element Sulzer SMX static mixer (available from Sulzer Chemtech (Koch) Pasadena, Tex.) 6″ after the last injection. Total flow is 0.985 gallons/minute; velocity is 0.41 ft/sec; the average mixer shear rate is 1428 sec−1; the mix energy is 75.2 HP/gallon.

The process results in a finished detergent with the composition shown in the attached table and a viscosity of 300 cp.

### Example 3

The process in example 1 is run. At a predetermine time, perfume injection is stopped. The dye injection is stopped 0.38 seconds after the perfume and the base flow is stopped 1.23 seconds after the perfume. The mix tank always contains good quality finished detergent and is pumped to the final container until substantially empty. Any remaining product is transferred to a small reblend tank located next to the process.

The process is restarted using past process parameters and the materials shown in the table below under example 3 (a new formulation). The perfume is injected at 150% of the target for 3.22 seconds and the dye is injected at 150% of target for 2.46 seconds. When the mix tank reaches the operating level, the composition is good quality, and then feed from the small reblend tank is started and the quality of the resulting product is continually monitored so that only good quality product is continually transferred to final containers. Thus normal operations have been resumed.

### Example 4

Five materials are fed sequentially into 3, 1″ confluence regions shown in the table. In the first confluence region, water is injected 12″ downstream of the base material. The first confluence region is followed by a first mixing section 6″ after the last injection as described below. In the second confluence region, polymer is injected 6″ downstream of the first mixing section. The second confluence region is followed by a second mixing section 6″ after the last injection as described below. In the third confluence region, perfume and dye are injected sequentially 6″ and 8″ downstream of the second mixing section respectively. The third confluence region is followed by a third mixing section 6″ after the last injection as described below. Each injection pipe is bent at a 90 angle to deliver the injected material parallel to the existing flow along the centerline of the pipe, and sized to give a material velocity within 20% of the average velocity of the existing flow.

Each mixing section consists of a 12 element SMX Static mixer (available from Sulzer Chemtech (Koch) Pasadena, Tex.). Total flow after the third confluence region is 1.98 gallons/minute; velocity is 0.82 ft/sec; the average mixer shear rate is 2870 sec−1; the mix energy is 161 HP/gallon for each mix region. The mix regions are followed by a mix tank. This is a 12″ diameter tank, with 9″ of liquid level. The mix tank contains an A310, 3″ diameter, low viscosity hydrofoil agitator (available from Chemineer Inc, Dayton Ohio). Mixer energy is 0.00031 hp/gallon and yielded a chemscale of 1. The mix tank continuously feeds the final container. A level controller maintains the liquid level by adjusting the outflow.

| Confluence | | | | |
|---|---|---|---|---|
| Region | Ingredient | Examples 1 & 2 | Example 3 | Example 4 |
| 1 | Detergent Base | 99.60% | 99.60% | 87.3% |
| | Perfume 1 | 0.24% | | |
| | Perfume 2 | | 0.24% | |
| | Blue Dye | 0.16% | | |
| | Water | | | 10% |
| 2 | PE-20 | | | 2.20% |
| 3 | Perfume 3 | | | 0.24% |
| | Blue Dye | | | 0.26% |

Example 5

| Ingredient | 5 |
|---|---|
| Ammonium Laureth-3 Sulfate | 11.2 |
| Sodium Sulfate | 4.0 |
| Cocamidopropyl Betaine | 1.7 |
| Sodium Lauroamphoacetate | 1.1 |
| Cationic Polymer (N-Hance 3196)^{a} | 0.39 |
| Trihydroxystearin^{b} | 0.33 |
| Sodium Benzoate | 0.28 |
| Citric Acid, anhydrous | 0.17 |
| Polyquaternium-10 | 0.11 |
| Disodium EDTA | 0.11 |
| Titanium Dioxide 328 | 0.11 |
| Polyox WSR N-3000^{c} | 0.056 |
| Kathon CG^{d} | 0.001 |
| Water | Balance |

### Example 5 Processing

A typical personal care liquid body wash base, water, 20% sodium sulfate solution, perfume, and dye are introduced continuously, according to the material balance in the attached table, sequentially in a confluence region of a ¾″ pipe. The water, sodium sulfate solution, perfume, and dye are added 12″, 14″, 18″, and 20″ downstream of the base respectively using an injection pipe. Each injection pipe is bent at a 90 angle to deliver the injected material parallel to the existing flow along the centerline of the pipe, and sized to give a material velocity within 20% of the average velocity of the existing flow. The confluence region is followed by a 16 element Sulzer SMX static mixer (available from Sulzer Chemtech (Koch) Pasadena, Tex.) 6″ after the last injection. Total flow is 7.48 gallons/minute; velocity is 4.99 ft/sec. The static mixer is followed by a mix tank. This is a 12″ diameter tank, with 9″ of liquid level. The mix tank contained an A310, 3″ diameter, low viscosity hydrofoil agitator (available from Chemineer Inc, Dayton Ohio). Mixer energy is 0.00031 hp/gallon and yielded a chemscale of 1. The mix tank continuously feeds the final container. A level controller maintains the liquid level by adjusting the outflow. The table below shows the addition of water, perfume, dye, and a promotional ingredient. The promotional ingredient would be added 22″ downstream of the base specified in the process above.

The process results in a finished body wash with the composition shown in the attached table and a viscosity of 8,000 cp.

| | | | Body |
|---|---|---|---|
| Confluence Region | Ingredient | Body Wash A | Wash B |
| 1 | Body Wash Base | 88.69% | 88.69% |
| | Water | 5.00% | 9.90% |
| | Sodium Sulfate Solution | 5.00% | |
| | (20%) | | |
| | Perfume 1 | 1.25% | 1.25% |
| | Blue Dye Solution | 0.06% | 0.06% |
| | Promotional ingredients | | 0.10% |

Example 7

| Ingredient | wt % |
|---|---|
| I. Cleansing Phase Composition | |
| Sodium Trideceth Sulfate (Cedepal TD-407, | 8.5 |
| Stepan) | |
| Sodium Lauryl Sulfate | 8.5 |
| Sodium Lauroamphoacetate (Miranol L-32) | 5.0 |
| Guar Hydroxypropyltrimonium Chloride | 0.6 |
| (N-Hance 3196 Aqualon) | |
| PEG 90M (Polyox WSR 301 from Dow | 0.15 |
| Chemical) | |
| Isosteareth-2 (Global Seven) | 2 |
| Trideceth-3 | — |
| Xanthan Gum (Keltrol 1000, CP Kelco) | 0.22 |
| Sodium Chloride | 4.75 |
| Disodium EDTA | 0.15 |
| Sodium Benzoate | 0.2 |
| Kathon CG | 0.03 |
| Perfume | 1.3 |
| Expancel 091 WE 40 d24 from Expancel, Inc. | 0.33 |
| Water | Q.S. |
| pH adjust to (use citric acid or NaOH) | 6.0 |
| II. Benefit phase Composition | |
| G2218 Petrolatum (WITCO) | 70 |
| Hydrobrite 1000 White Mineral Oil, WITCO | 29.99 |
| Red 7 Cosmetic Pigment | 0.01 |
| Cleansing Phase:Benefit Phase Ratio | 75:25 |

### Example 7 Processing

A personal care liquid body wash base, water, perfume, dye and promotional ingredients are introduced continuously according to the material balance in the attached table, sequentially in a confluence region of a 1″ pipe creating a cleansing phase as in Example 1. The water, perfume, and dye and promotional ingredients are added anywhere from 2″ to 20″ downstream of the body wash base respectively using an injection pipe. Each injection pipe is bent at a 90 angle to deliver the injected material parallel to the existing flow along the centerline of the pipe, and sized to give a material velocity within 20% of the average velocity of the existing flow. The confluence region is followed by an 18 element Sulzer SMX static mixer (available from Sulzer Chemtech (Koch) Pasadena, Tex.) 2″ to 16″ after the last injection. Total flow is 6 gallons/minute. The static mixer is followed by a mix tank, which contains a, low viscosity hydrofoil agitator (available from Chemineer Inc, Dayton Ohio). The mix tank continuously feeds the final container where the benefit phase is mixed in. A level controller maintains the liquid level by adjusting the outflow. In the table below, Embodiment A shows adding perfume only, Embodiment B shows adding perfume, dye solution and promotional ingredients; and Embodiment C shows adding water, perfume, dye solution and promotional ingredients.

| Confluence Region | Ingredient | A | B | C |
|---|---|---|---|---|
| 1 | Body Wash | 98.7% | 98.627% | 78.627% |
| | Base | | | |
| | Water | | | 20.00% |
| | Perfume 1 | 1.30% | 1.30% | 1.30% |
| | Dye Solution | | 0.06% | 0.06% |
| | Promotional | | 0.013% | 0.013% |
| | ingredients | | | |

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process comprising:
a.) contacting, in one or more confluence regions:
(i) at least two base materials; or
(ii) at least two finishing materials; or
(iii) one or more base materials and one or more finishing materials; and
(iv) optionally one or more reblends
b.) mixing said at least two base materials; or at least two finishing materials;
or one or more base materials and one or more finishing materials and said optional one or more reblends in
(i) said one or more confluence regions; or
(ii) one or more regions outside of said one or more confluence regions; or
(iii) in a combination of said one or more confluence regions and one or more regions outside of said one or more confluence regions;
c.) placing said at least two base materials; or at least two finishing materials;
or one or more base materials and one or more finishing materials and said optional one or more reblends in a container.

2. The process of claim 1 comprising contacting said at least two base materials; or at least two finishing materials; or one or more base materials and one or more finishing materials with one or more reblends in said one or more confluence regions.

3. The process of claim 1 comprising contacting said at least two base materials; or at least two finishing materials; or one or more base materials and one or more finishing materials; and optionally one or more reblends in more than one confluence region.

4. The process of claim 1 comprising contacting said at least two base materials; or at least two finishing materials; or one or more base materials and one or more finishing materials; and optionally one or more reblends in a single confluence region.

5. The process of claim 1, comprising mixing said at least two base materials; or at least two finishing materials; or one or more base materials and one or more finishing materials and optionally one or more reblends in:
a.) more than one confluence region; or
b.) more than one region outside of said confluence regions; or
c.) in a combination of said more than one confluence regions and more than one region outside of said confluence regions.

6. The process of claim 1, comprising at least partially mixing said at least two base materials; or at least two finishing materials; or one or more base materials and one or more finishing materials and optionally one or more reblends in a single confluence region.

7. The process of claim 1, comprising mixing said at least two base materials; or at least two finishing materials; or one or more base materials and one or more finishing materials; and optionally one or more reblends, at least partially, in said container.

8. The process of claim 1, comprising contacting said at least two base materials; or at least two finishing materials; or one or more base materials and one or more finishing materials; and optionally one or more reblends simultaneously, sequentially or in any combination thereof.

9. The process of claim 1, said contacting step being conducted such that one or more of the following apply:
a.) the materials being placed in contact are in parallel flow at the time of contact;
b.) that the flow velocities of the materials being placed in contact are, at the point of contact, from about 50% to about 500% of the velocity of the previously injected materials.
c.) the material having the smallest volumetric flow is introduced such that said flow is along the centerline of the confluence region.

10. The process of claim 1 comprising mixing, in whole or in part, via turbulent flow mixing, static mixing, dynamic mixing or a combination thereof.

11. The process of claim 1 comprising mixing in line, off-line or a combination thereof.

12. The process of claim 1 comprising mixing under one or more of the following processing conditions:
a.) average shear rate is greater than about 10 sec⁻¹;
b.) power per unit volume greater than about 0.01 horsepower/gallon;
c.) when a back mix tank is employed, mixing in said tank under one or more of the following process conditions:
(i) residence time of the material in said back mix tank is greater than about 5 seconds;
(ii) the power per unit volume, in horsepower/gallon of material in said tank, is from about 0.000001 to about 0.15;
(iii) the Chemscale of mixing is from about 0.5 to about 10.

13. The process of claim 1 said process being conducted such that the process residence time of the first material to enter the first confluence region is less than about 5 minutes.

14. A process of reducing scrap and/or reblend comprising one or more of the following:
a.) positioning one or more confluence regions, in relation to a container, such that the process residence time of the first material to enter the first confluence region is less than about 5 minutes;
b.) stopping or reducing the input of a material selected from the group consisting of a base material, a finishing material a reblend material or combination thereof into a confluence region;
c.) purging said one or more confluence regions;
d.) introducing an excess of a material selected from the group consisting of a base material, a finishing material a reblend material or combination thereof into a confluence region.

15. The process of claim 14, said process comprising purging with a composition that has a material composition that results from stopping or reducing the input of a material selected from the group consisting of a base material, a finishing material, or a reblend material.

16. The process of claim 14, said process comprising purging with a composition selected from the group consisting of a base material, a finishing material, a reblend material, air, steam, water or combination thereof.

17. The process of claim 14, wherein said excess material is compositionally different from said material that is stopped or reduced.

18. The process of claim 14 comprising purging any outlet region downstream of said one or more confluence regions.

19. The process according to claim 14 comprising operating a processing system comprising a dynamic mix region positioned downstream of said one or more confluence regions and an outlet region downstream of said dynamic mix region, as follows:
a.) sequentially stopping the input of one or more base materials, finishing materials and/or reblends in to said one or more confluence regions while maintaining the input of at least one other base material, finishing material and/or reblend in to said one or more confluence regions;
b.) stopping the input of said at least one other base material, finishing material and/or reblend in to said one or more confluence regions when said at least one other base material, finishing material and/or reblend reaches the input to said dynamic mix region;
c.) substantially emptying said dynamic mix region and optionally purging said outlet region;
d.) supplying to said dynamic mix region said at least one other base material, finishing material and/or reblend contained in said confluence region, and a sufficient amount of additional base materials, finishing materials and/or reblends to said dynamic mix region to form product in said dynamic mix region;
e.) regulating the input of base materials, finishing materials and/or reblends into said one or more confluence regions such that the formation of product in said dynamic mix region is maintained.

20. The process of claim 19 wherein said at least one other base material, finishing material and/or reblend comprises water.

21. The process of claim 19 wherein said outlet region is substantially purged.

22. The process of claim 1 wherein the last material supplied to the confluence region comprises a base material, finishing material or reblend said base material, finishing material or reblend being supplied after the process flow has been dynamically mixed and, after said base material, finishing material or reblend has been added to said process flow, said process flow being optionally further mixed, said further mixing being optionally conducted via a static mixer.

23. A cleaning composition produced according to the process of claim 1.
